(19) United States
(12) Patent Application Publication
(10) Pub. No.: US 2026/0099757 A1
(43) Pub. Date: Apr. 9, 2026

(54) HARDWARE AND PARAMETER-AWARE MACHINE LEARNING MODEL GPU EFFICIENCY TUNING SYSTEMS

(71) Applicant: Microsoft Technology Licensing, LLC, Redmond, WA (US)

(72) Inventors: Pin-Lun HSU, Sunnyvale, CA (US); Vignesh KOTHAPALLI, Mountain View, CA (US); Animesh SINGH, Santa Clara, CA (US); Qingquan SONG, Sunnyvale, CA (US); Yun DAI, Santa Clara, CA (US); Shao TANG, Cupertino, CA (US)

(21) Appl. No.: 18/906,517

(22) Filed: Oct. 4, 2024

(51) Int. Cl. G06N 20/00

(52) U.S. Cl. CPC G06N 20/00

(57) ABSTRACT

Aspects of the disclosure include methods and systems for machine learning, and specifically to hardware and parameter-aware machine learning (ML) model graphics processing unit (GPU) efficiency tuning systems. A method includes receiving a request corresponding to a machine learning model training task, a plurality of fixed configurations, and a plurality of dynamic configurations. A task embedding is generated from the plurality of fixed configurations. A prediction module is trained on known dynamic and fixed configurations and, for each combination of a dynamic configuration and a fixed configuration, a respective model utilization score. A plurality of model utilization scores are generated for a plurality of respective candidate configurations sampled from the dynamic configurations.

Responsive to receiving the request, a response is returned including an optimal training efficiency configuration for the training task according to the plurality of model utilization scores.

### INTRODUCTION

The subject disclosure relates to machine learning, and specifically to hardware and parameter-aware machine learning (ML) model graphics processing unit (GPU) efficiency tuning systems.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 illustrates a block diagram of a single task search flow in accordance with one or more embodiments;

FIG. 2 illustrates a search transfer process for a target task in accordance with one or more embodiments;

FIG. 3 illustrates an offline bootstrapping phase and an online informed tuning phase of a hardware and parameter-aware large language model (LLM) graphics processing unit (GPU) efficiency tuning system in accordance with one or more embodiments;

FIG. 4 illustrates a block diagram of a search process flow for optimizing large language model training configurations in accordance with one or more embodiments;

FIG. 5 illustrates a block diagram of a process for generating model execution graphs in accordance with one or more embodiments;

FIG. 6 illustrates an example transformer-type implementation for an LLM GPU efficiency tuning system in accordance with one or more embodiments;

FIG. 7 illustrates a block diagram of a computer system according to one or more embodiments; and

FIG. 8 illustrates a flowchart of a method in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

Model training is a fundamental process in machine learning where a model learns to make predictions or decisions based on training data. Training often involves feeding a model training data (that is, data having known labels) and allowing the model to adjust its internal parameters (e.g., weights) to minimize errors in its predictions of those labels. The goal of model training is to create a model that can generalize well to new, unseen data, thereby making accurate predictions or decisions in real-world scenarios.

The compute and time required for model training is proportional to the complexity of the underlying model. Thus, as models themselves have become increasingly more complex, the compute and time requirements for model training have increased similarly. For example, training large language models (LLMs) involves significant computational resources and time. LLMs can include billions of parameters, and as their datasets grow larger, managing the computational resources used for model training and reducing training times has become essential.

Unfortunately, current solutions for optimizing machine learning (ML) model training efficiency often involve manual processes, where a search space of possible configurations is manually explored and candidate configurations are manually checked to determine performance. Manual tuning of training configurations is time-consuming and requires expert knowledge, making manual tuning impractical for large-scale applications. Additionally, brute-force search methods for optimizing configurations are computationally expensive and inefficient, often leading to suboptimal results. These approaches fail to leverage the potential of automated, trained machine learning systems that can intelligently navigate a configuration space to find optimal settings.

This disclosure introduces a hardware and parameter-aware ML model graphics processing unit (GPU) efficiency tuning system. Rather than exhaustively and/or naively exploring a configuration parameter search space, the hardware and parameter-aware ML model GPU efficiency tuning system described herein auto-detects hardware and model configurations to optimize GPU efficiency, significantly reducing training times and costs. By employing a combination of dynamic and fixed configurations, the system predicts scores for a selected model utilization metric, such as model floating-point operations per second (FLOPS) utilization (MFU) scores for a training task, and guides the exploration of configurations based on this prediction. This approach avoids the computational overheads associated with inefficient random searches and streamlines the tuning process, allowing AI practitioners to focus on modeling rather than tuning.

The hardware and parameter-aware ML model GPU efficiency tuning system described herein offers a number of architectural advantages over manual and naïve approaches to training configuration search. Efficiency tuning, which involves optimizing the configurations of the training process, often gets neglected due to its complexity. Efficiency tuning is difficult due to the number of hyperparameters involved and the nonlinear interactions between them. In other words, the search space for efficiency tuning can be large, even for a somewhat modest number of hyperparameters. For example, consider a scenario in which a relatively simple ML model has 10 different hyperparameters, each with 5 possible values. The total number of possible configurations would be 5¹⁰, or 9,765,625. Even for this simplified case, evaluating each possible configuration to find the optimal one would be impractical (as used herein, an “optimal” configuration is one that maximizes training efficiency—that is, to maximize a selected model utilization metric, such as model floating-point operations per second (FLOPS) utilization (MFU) scores). The configuration search space for large models having millions or even billions of parameters is orders of magnitude larger. Consequently, current approaches often rely on the expertise of subject matter experts to leverage their knowledge of machine learning and the specific model being trained to select configurations without conducting an exhaustive search. This type of manual approach can be thought of as a substantial under-sampling of the search space and can lead to extensive usage of computational resources, particularly GPUs, which are critical for training large ML models. Providing an architecture that can automatically optimize configurations can significantly reduce training times, as demonstrated by reductions in alignment training and embedding training durations. Automatically detecting hardware and model configurations to optimize efficiency can streamline the model tuning process, reduce compute requirements and training times, freeing resources for other tasks.

Moreover, this approach to efficiency tuning can be leveraged to identify configurations for any underlying machine learning model which benefits from parameter optimization during training such as, for example, recurrent neural networks (RNNs), long short-term memory (LSTM) models, large language models, etc.

### DETAILED EMBODIMENT

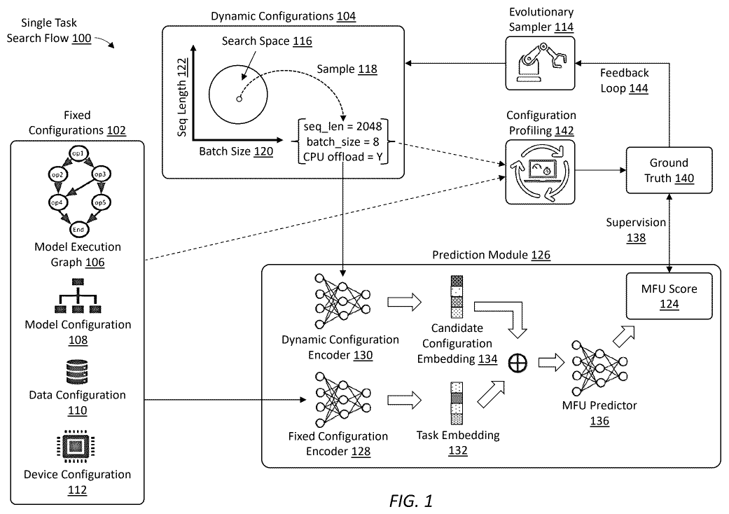

FIG. 1 depicts a block diagram of a single task search flow 100 in accordance with one or more embodiments. As shown in FIG. 1, the single task search flow 100 includes fixed configurations 102 (also referred to as non-searchable configurations) and dynamic configurations 104 (also referred to as searchable configurations or as adjustable configurations). The fixed configurations 102 and dynamic configurations 104 jointly refer to the complete space of configurations involved with a training task. Specifically, fixed configurations 102 refer to fixed training parameters that are predetermined and not subject to optimization or tuning during the training process, while dynamic configurations 104 refer to variable parameters (also referred to as searchable parameters or adjustable parameters) that can be adjusted and optimized to improve the efficiency of a training process. Unlike fixed configurations 102, searchable parameters directly influence the computational resource usage and performance of a model training task.

More specifically, fixed configurations 102 are essential for defining the structure and environment in which a model operates and can include model architecture definitions, datasets, and available hardware. In some embodiments, the fixed configurations 102 include a model execution graph 106 (e.g., a CUDA graph), a model configuration 108, a data configuration 110, and a device configuration 112.

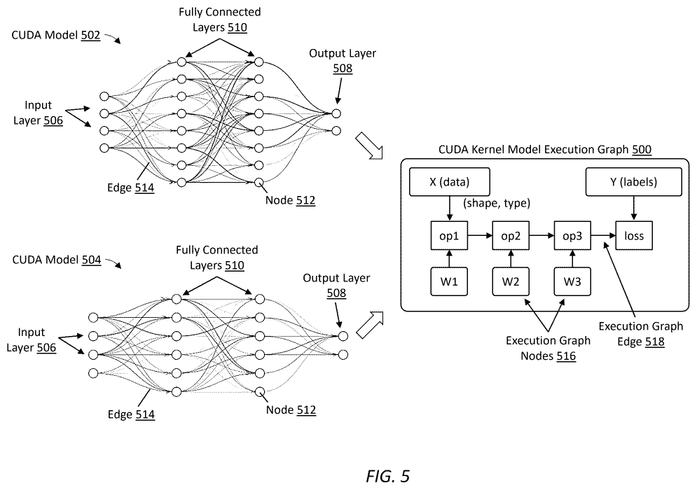

The model execution graph 106 includes a directed graph (that is, a sequence of nodes) that fully defines the mathematical sequence of operations that a model performs during its execution on a GPU. The model execution graph 106 serves as a baseline for ensuring that a model's computations are correctly executed. For example, one type of model execution graph 106 is the CUDA (Compute Unified Device Architecture) graph, and more specifically, the CUDA kernel model execution graph. A CUDA kernel execution graph refers to a directed acyclic graph (DAG) where each node represents a computational operation (or kernel) and each edge represents the data dependencies between these operations. An example CUDA kernel execution graph is discussed in greater detail below with respect to FIG. 5.

Model configuration 108 includes the set of fixed parameters that define the architecture of the respective model of a training task, such as the type of model that will be used for the training task (e.g., Llama2-7B, Llama3-70B, Mixtral 8×7B, etc.), the number of layers in that model, and other structural details.

Data configuration 110 includes the set of parameters that detail how the training data is organized, such as sequence length (e.g., 4K Sequence Length, 8K Sequence Length, etc.) and dataset size. These parameters are fixed based on the nature of the data and the specific requirements of the training task.

Device configuration 112 includes the set of hardware specifications of the hardware resources available for a given training task, such as the number and type of GPUs (e.g., 8 A100 GPUs, 8 H100 GPUs, etc.) and the number of nodes in a distributed setup (e.g., 2 nodes with 16 H100s, 4 nodes with 32 H100s, etc.). Device configurations 112 are determined by the available infrastructure and are not subject to change during the tuning process.

Turning now to the dynamic configurations 104, these parameters include the set of training efficiency configurations to be explored and/or searched for a training task and include, for example, tunable training hyperparameters that can be adjusted and optimized to improve the efficiency of the training process. Dynamic configurations 104 are not strictly limited to hyperparameters and can include any tunable training parameters that can be adjusted and optimized to improve the efficiency of the training process, such as, for example, gradient checkpointing, which is not technically a hyperparameter since it does not affect the learning pattern of underlying model. Unlike fixed configurations 102, the dynamic configurations 104 directly influence the computational resource usage and performance of a model training task. The goal of tuning these configurations is to find the optimal settings that maximize training efficiency—that is, to maximize a selected model utilization metric, such as model floating-point operations per second (FLOPS) utilization (MFU) scores, for a training task. While the single task search flow 100 is discussed primarily in the context of maximizing MFU scores, this is for illustrative purposes only. Other model utilization metrics are possible, such as memory utilization (e.g., the percentage of GPU memory used during training), streaming multiprocessor (SM) efficiency (e.g., the utilization of the streaming multiprocessors within the GPUs), instruction throughput (e.g., the number of instructions executed per cycle), memory throughput (e.g., the amount of data transferred between the GPU memory and the computational units per cycle), cache hit rates (e.g., the percentage of memory accesses that are served by a GPU's cache), warp efficiency (e.g., the percentage of active threads within a group of threads executed simultaneously on a GPU), branch efficiency (e.g., the effectiveness of branch instructions such as if-else statements within the GPU), and occupancy (e.g., the ratio of active warps to the maximum number of warps supported by the GPU), and all such model utilization metrics are within the contemplated scope of this disclosure.

In some embodiments, the dynamic configurations 104 include training efficiency configurations that affect speed and memory consumption during training without altering the underlying model's accuracy. Examples include the selection of various memory efficient techniques (e.g., gradient checkpointing, gradient accumulation, etc.) that help manage memory usage during training), the use or non-use of distributed training strategies (e.g., techniques such as ZeRO (Zero Redundancy Optimizer), FSDP (Fully Sharded Data Parallel), HSDP (Hybrid Sharded Data Parallel), Tensor Parallelism, and Pipeline Parallelism, etc.) that distribute a training workload across multiple GPUs and/or nodes to improve efficiency, the use or non-use of FSDP prefetching or other techniques to prefetch data to improve training speed, and the use or non-use of CPU offloading or other techniques to offload specified computations to the CPU to free up GPU resources. In some embodiments, the dynamic configurations 104 include training hyperparameters, such as sequence length (the length of the input sequences used during training) and batch size (the number of training examples used in one iteration of training). Other dynamic configurations 104 include padding strategies, max padding length, autotuning parameters, selective gradient checkpointing granularity, etc.

In the context of the single task search flow 100, dynamic configurations 104 are explored and optimized using a combination of model-based sampling techniques and evolutionary algorithms. The single task search flow 100 predicts model utilization metrics (e.g., MFU scores) for various candidate configurations and guides the exploration process to avoid inefficient random searches. By focusing on tunable parameters, the single task search flow 100 can significantly reduce training times and computational costs, allowing AI practitioners to achieve optimal training efficiency for their machine learning models.

As further shown in FIG. 1, the single task search flow 100 includes an evolutionary sampler 114 (also referred to as an evolutionary configuration sampler and calibrator). In some embodiments, the evolutionary sampler 114 employs evolutionary algorithms to navigate a search space 116 of possible dynamic configurations 104, avoiding the inefficiencies of random or brute-force search methods. In some embodiments, the evolutionary sampler 114 initializes a population of candidate configurations in the search space 116. Specifically, the evolutionary sampler 114 selects, from the search space 116, one or more samples 118 (also referred to as evolutionary search candidates). The samples 118 can be generated randomly or based on prior knowledge or heuristics. Each candidate configuration consists of a set of values for the dynamic configurations 104, such as batch size, learning rate, and distributed training strategies.

In some embodiments, the samples 118 are generated based on evolutionary algorithms, which use techniques such as mutation and crossover to explore the search space efficiently. For example, in some embodiments, the evolutionary sampler 114 begins by initializing a population of candidate configurations (one or more samples 118). For example, if the search space 116 includes batch size 120, sequence length 122, and other parameters (e.g., learning rate, CPU offloading, gradient checkpointing, etc.), the initial population might consist of random combinations of these parameters. For example, candidate 1 might have a batch size 120 set to 32, a learning rate set to 0.001, and gradient checkpointing set to “on”; candidate 2 might have a batch size 120 set to 64, a learning rate set to 0.0005, and gradient checkpointing set to “off”; candidate 3 might have a batch size 120 set to 128, a learning rate set to 0.0001, and gradient checkpointing set to “on”.

In some embodiments, the evolutionary sampler 114 evaluates the initial population of samples 118 based on their MFU scores 124 (discussed in greater detailed below) and selects a set of top-performing candidates (e.g., those candidates having the highest MFU scores 124). For instance, if candidate 1 and candidate 3 have the highest MFU scores 124, they are selected as parents for the next generation. These candidates can be referred to as parent candidates.

In some embodiments, the evolutionary sampler 114 creates new candidates by mutating one or more of the parent candidates. Mutation involves randomly altering one or more parameters in a parent configuration to create a new candidate. For example, a parent configuration having a batch size 120 set to 32, a learning rate set to 0.001, and gradient checkpointing set to “on” can be mutated to produce a new candidate having a batch size 120 set to 32, a learning rate set to 0.002, and gradient checkpointing set to “on”. In this example, the learning rate is randomly altered from 0.001 to 0.002, creating a new candidate configuration.

In some embodiments, the evolutionary sampler 114 creates new candidates via a crossover procedure. Crossover involves combining parts of two or more parent configurations to create a new candidate. For example: a first parent configuration having a batch size 120 set to 32, a learning rate set to 0.001, and gradient checkpointing set to “on” and a second parent configuration having a batch size 120 set to 128, a learning rate set to 0.0001, and gradient checkpointing set to “off” can be used via crossover to generate a new candidate configuration having a batch size 120 set to 32, a learning rate set to 0.0001, and gradient checkpointing set to “off”. In this example, the batch size 120 is taken from the first parent, while the learning rate and gradient checkpointing settings are taken from the second parent, creating a new candidate configuration.

In some embodiments, the samples 118 and/or new candidate configurations generated through mutation and/or crossover are evaluated by the prediction module 126 (discussed in greater detail below). Notably, the MFU scores 124 for these candidates are predicted by the prediction module 126 without performing actual training, saving computational resources.

In some embodiments, the evolutionary sampler 114 iterates through the selection, mutation, crossover, and evaluation steps for multiple generations. Each iteration refines the population of candidate configurations, gradually improving the overall efficiency of the training process. For example, after several generations, the population might evolve to include highly efficient configurations such as, for example, an optimized candidate 1 having a batch size 120 set to 64, a learning rate set to 0.0005, and gradient checkpointing set to “on”, and an optimized candidate 2 having a batch size 120 set to 128, a learning rate set to 0.0002, and gradient checkpointing set to “on”.

In some embodiments, this iterative evolutionary process continues until the evolutionary sampler 114 converges on an optimal or near-optimal configuration (according to any predetermined threshold model utilization metric, such as an MFU requirement). Convergence can be determined based on criteria such as a maximum number of generations, a threshold model utilization score, or a lack of significant improvement over successive generations (again, according to any predetermined threshold).

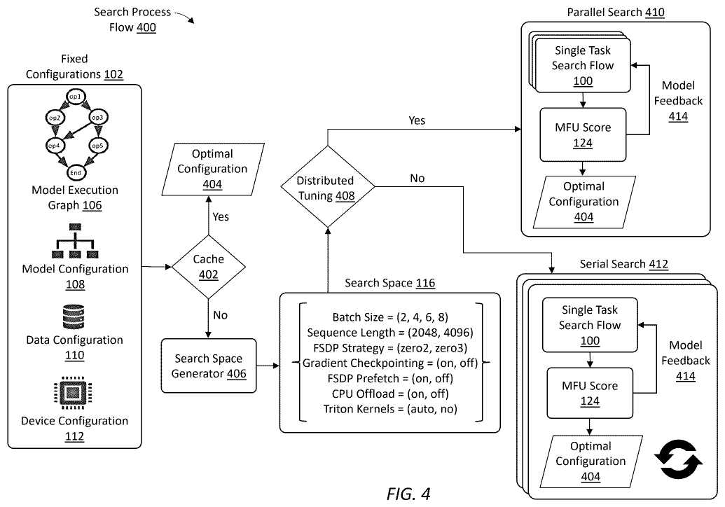

In some embodiments, the final output of the evolutionary sampler 114 and/or the single task search flow 100 is the candidate configuration with the highest MFU score 124 (or any other selected model utilization metric), representing the optimal training efficiency configuration for the large language model training task. This configuration can be returned as the response to a training task (refer to FIG. 4).

Turning now to the prediction module 126 and the generation of MFU scores 124, in some embodiments, the prediction module 126 includes a fixed configuration encoder 128 and a dynamic configuration encoder 130. The fixed configuration encoder 128 is trained to generate a task embedding 132 from the fixed configurations 102, and the dynamic configuration encoder 130 is trained to generate a candidate configuration embedding 134 for a given sample 118.

In some embodiments, the fixed configuration encoder 128 transforms the fixed, fixed configurations 102 into a high-dimensional task embedding 132. This task embedding 132 serves as a first (static) reference point for evaluating and optimizing the dynamic configurations 104.

In some embodiments, the fixed configuration encoder 128 extracts relevant features from each of the input fixed configurations 102. This step involves converting the raw input parameters into a format suitable for further processing. For example, the model execution graph 106 can be converted into a numerical representation that captures the sequence and dependencies of the underlying operations. The model type, size, and other architectural details of the model configuration 108 can be encoded into numerical or categorical features. Parameters for data configuration 110, such as sequence length and dataset size, and device configuration 112, such as the number and type of GPUs, can be converted into numerical features as well.

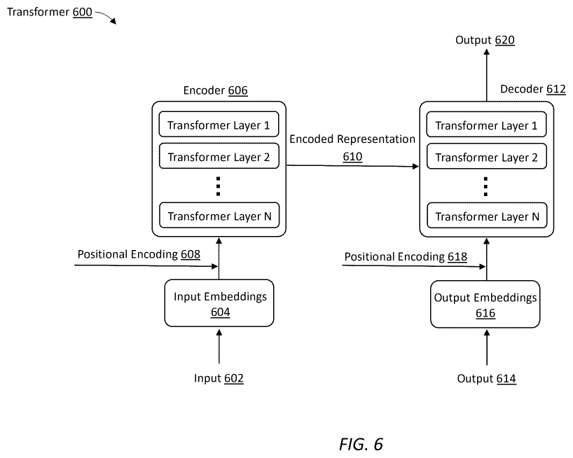

In some embodiments, the extracted features are then processed to generate the task embedding 132. An embedding is a dense, high-dimensional vector representation that captures the relationships and interactions between different features. The embedding generation step typically involves the use of neural networks or other machine learning models (e.g., large language model encoders and/or decoders, etc.) to learn the embeddings from the input features. Encoders, decoders, and the generation of embeddings are discussed in greater detail with respect to FIG. 6.

In some embodiments, the dynamic configuration encoder 130 transforms the variable, dynamic configurations 104 into a high-dimensional candidate configuration embedding 134. This candidate configuration embedding 134 serves as a second reference point for evaluating and optimizing the dynamic configurations 104.

In some embodiments, the dynamic configuration encoder 130 extracts relevant features from each of the input dynamic configurations 104 (that is, for each sample 118). This step involves converting the raw input parameters into a format suitable for further processing, in a similar manner as described with respect to the task embedding 132. For example, batch size 120, sequence length 122, and gradient checkpointing can be converted into numerical representations. In some embodiments, the extracted features are then processed to generate the candidate configuration embedding 134, in a similar manner as described with respect to the task embedding 132.

To further illustrate the generation of embeddings, consider the following example scenario from the perspective of the candidate configuration embedding 134 (a similar procedure is followed for the task embedding 132). First, an input sample 118 might include batch size=64, learning rate=0.001, gradient checkpointing=On, distributed training strategy=ZeRO. Feature extraction might result in the following numerical representations: [64], [0.001], [1], and [1, 0, 0, 0] (a one-hot encoding for ZeRO), respectively. Embedding generation might result in the following internal embeddings: [0.5, 0.3, 0.2, 0.1] for batch size, [0.4, 0.6] for learning rate, [0.7] for gradient checkpointing, and [0.15, 0.22, 0.88, 0.05] for the distributed training strategy. These embeddings can be concatenated to form a single output vector: [0.5, 0.3, 0.2, 0.1, 0.4, 0.6, 0.7, 0.15, 0.22, 0.88, 0.05]. In some embodiments, this output vector is the candidate configuration embedding 134 (or task embedding 132), although one or more post-processing steps can be applied to the output vector to generate the respective embeddings and all such configurations are within the contemplated scope of this disclosure.

In some embodiments, the task embedding 132 and the candidate configuration embedding 134 are themselves concatenated into a single vector representation that is fed to an MFU predictor 136. The MFU predictor 136 is a model that is trained to predict the efficiency of candidate configurations in terms of their model FLOPs utilization (MFU) from the concatenated inputs of the task embedding 132 and the candidate configuration embedding 134. Additionally, or alternatively, the MFU predictor 136 can be trained to predict the efficiency of candidate configurations in terms of any other selected model utilization metric, as discussed previously. The MFU score 124 that is output for a given configuration (e.g., some sample 118 and the fixed configurations 102) represents the computational efficiency of that respective configuration, with higher scores indicating more efficient configurations. Notably, the MFU predictor 136 helps guide the search and optimization process by providing a way to evaluate candidate configurations without performing actual training, thereby saving computational resources (both compute and time).

In some embodiments, the MFU predictor 136 is a neural network or other machine learning architecture that is trained to take concatenated embeddings (that is, a task embedding 132 and a candidate configuration embedding 134) as input and to output an MFU score 124 (or any other selected model utilization metric) for the respective candidate configuration. The MFU predictor 136 can be trained using a dataset of known model configurations and their respective MFU scores 124. For example, concatenated embeddings from a known configurations can be generated and fed to the MFU predictor 136 during a training phase with the actual (known) MFU scores 124 for those respective configurations as the target output. Internal weights of the MFU predictor 136 can then be adjusted using supervised and/or unsupervised learning techniques (collectively, “supervision 138”) with an objective of minimizing a difference between the predicted model utilization scores and the actual model utilization scores (the “ground truth 140”). Loss functions, such as mean squared error (MSE) or ranking loss (e.g., InfoNCE contrastive loss, lambda loss, etc.), can be used to train the MFU predictor 136 by adjusting model weights using various techniques, and all such configurations are within the contemplated scope of this disclosure. In some embodiments, the MFU predictor 136 is validated post-training (or during training) on a separate validation dataset to ensure its accuracy and generalization capability. During this process (and following) the MFU predictor 136 can be fine-tuned (weights can be further adjusted) as needed to improve performance. Once trained, the MFU predictor 136 can be used to generate MFU scores 124 for currently untested configurations (e.g., samples 118 for which the respective MFU score 124 is not empirically known), thereby allowing the single task search flow 100 to evaluate new candidate configurations during the optimization process without actually requiring rigorous testing of the training efficiency of the underlying model using various potential training configurations.

As further shown in FIG. 1, the single task search flow 100 includes configuration profiling 142 and a feedback loop 144. As discussed previously, the evolutionary sampler 114 interacts with the search space 116 to sample candidate configurations from the dynamic configurations 104. In some embodiments, some of the sampled configurations are then profiled during configuration profiling 142 to generate ground truth 140 data. For example, in some embodiments, configuration profiling 142 includes evaluating candidate configurations by running a selection of those configurations through a profiling process to measure their actual performance. More specifically, configuration profiling 142 can include profiling a candidate configuration by running a subset of the training process. The profiling process measures the actual MFU score 124 for this configuration, providing an ground truth 140 performance metric. The feedback loop 144 involves using the ground truth 140 data to provide supervision and guidance to the evolutionary sampler 114 and the MFU predictor 136. Feedback loop 144 refines the search process and improves the accuracy of the MFU score 124 predictions by routing a comparison of profiling data and MFU scores 124 to the evolutionary sample 114. For example, the ground truth 140 score of 0.75 for an example candidate configuration can be compared with the predicted MFU score 124 generated by the MFU predictor 136. If there is a significant discrepancy between the predicted and actual scores (using any desired predetermined threshold), the feedback loop 144 provides this information to the evolutionary sampler 114 and/or the MFU predictor 136. In some embodiments, the evolutionary sampler 114 uses this feedback to adjust its sampling strategy, while the MFU predictor 136 uses this feedback to fine-tune its model parameters, improving future predictions.

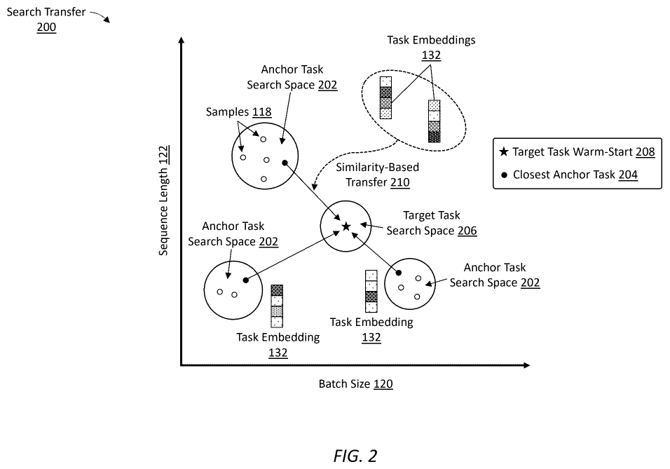

FIG. 2 depicts a search transfer 200 for a target task in accordance with one or more embodiments. Search transfer 200 is a process that involves leveraging previously tuned configurations (anchor tasks) during online tuning to accelerate the search for optimal configurations for a new target task. As an overview, search transfer 200 includes encoding the various fixed configurations 102 of a target task as a task embedding 132 (refer to FIG. 1) and determining a similarity (e.g., dot product) of the task embedding 132 of the target task against task embeddings 132 of one or more anchor tasks (prior tasks having known task embeddings 132, refer to configuration profiling 142 and ground truth 140 in FIG. 1). Then, based on any desired distance measure in each respective anchor task search space 202, the “closest” anchor tasks 204 having a highest similarity to the target task for which an optimal training configuration is desired are selected. Lastly, the best hyperparameter of each filtered anchor task can then be combined via a process referred to herein as similarity-based transfer 210 (e.g., a weighted sum of anchor task hyperparameters, with weights defined as the SoftMax of the similarities) and a calibration can be applied to adjust each configuration hyperparameter in the derived configuration to its closest valid value in a target task search space 206. This calibrated configuration can be leveraged as a warm-start configuration (referred to as the target task warm-start 208) for direct adoption on the target task or for continual tuning.

To illustrate, consider a scenario in which an optimal training configuration is desired for a target task (the training of a model for which an optimal training configuration is unknown). The target task will have fixed configurations 102 and dynamic configurations 104, as described previously with respect to FIG. 1. One or more anchor task search spaces 202 can be explored to find the closest anchor tasks 204 to the target task (that is, the anchor tasks having task embeddings 132 that are closest to the task embedding 132 of the target task). Each anchor task search space 202 represents a range of possible dynamic configurations 104 for the respective non-searchable configuration 102 that have been explored and optimized for the respective anchor task. Observe that each anchor task search space 202 can include one or more anchor tasks, with each anchor task within a given anchor task search space 202 defined according to their own selection of dynamic configurations 104. For example, an example anchor task search space 202 might focus on the tuning of the Llama3-70B model using supervised fine-tuning on a specific dataset. The fixed configurations 102 for that respective anchor task search space 202 can include the model type (e.g., Llama3-70B), model CUDA graph, dataset size, etc.

Within that particular search space, various anchor tasks can be defined according to their specific instances of the dynamic configurations 104. These anchor tasks can then be evaluated to determine their similarity to the target task. Example anchor tasks within this search space might include, for example, a first anchor task defined as: [batch size=32, learning rate=0.0001, gradient checkpointing=On, distributed training strategy=FSDP] having a known MFU Score=0.80 and a second anchor task defined as: [batch size=64, learning rate=0.007, gradient checkpointing=Off, distributed training strategy=tensor parallelism] having a known MFU Score=0.65.

Once the anchor task search spaces 202 are defined (alongside their respective anchor tasks), the configurations of the closest anchor tasks 204 can then used to inform the initial search space and warm-start configuration for the target task. This process, referred to as similarity-based transfer 210, can include a weighted sum combination of the dynamic configurations 104 of the respective closest anchor tasks 204, with weights determined based on the similarity scores and higher similarity scores receiving higher weights (and vice versa). For example, if a first anchor task has a similarity score of 0.9 and a second anchor task has a similarity score of 0.8, the dynamic configurations 104 from these tasks are combined using weights of 0.9 and 0.8, respectively. In some embodiments, similarity-based transfer 210 includes (or requires) a calibration step whereby each hyperparameter in the combined configuration is adjusted, if necessary, to its closest valid value in the target task search space 206. Calibration is necessary when a parameter's weighted sum value is not a valid configuration parameter. For example, if a first anchor task has a similarity score of 0.9 and a batch size of 64, and a second anchor task has a similarity score of 0.6 and a batch size of 256, the weight sum batch score value might be 140.8 (e.g., giving a 60 percent weighting to the first anchor task and a 40 percent weighting to the second anchor task according to the formula, for the first anchor task, (0.9+0.6)/1.5)), which is not a valid parameter value for batch size. Thus, in this scenario, batch size can be adjusted to the closest valid value, for example, 128.

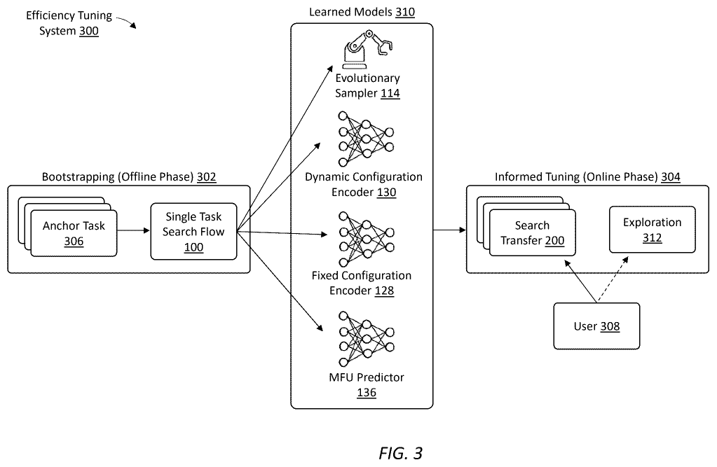

FIG. 3 depicts a hardware and parameter-aware machine learning (ML) graphics processing unit (GPU) efficiency tuning system 300 in accordance with one or more embodiments. As shown in FIG. 3, the efficiency tuning system 300 includes an offline bootstrapping phase 302 and an online informed tuning phase 304.

The goal of the offline bootstrapping phase 302 is to explore several predefined anchor tasks 306 (refer to FIG. 2), which consist of various fixed configurations 102, such as a selection of representative models, data, and device configurations, and, from that information, to derive, for a given training task, (1) the best dynamic configurations 104 for the respective task (e.g., the optimal sequence length, batch size, distributed training config, etc.), (2) an evolutionary sampler 114 tailored to each respective task for iterative tuning (refer to FIG. 1), (3) two separate global configuration encoders shared across tasks (e.g., the dynamic configuration encoder 130 and the fixed configuration encoder 128 used for encoding the dynamic configurations 104 and the fixed configurations 102, respectively, into embeddings, (4), an MFU predictor 136 shared across tasks for predicting MFU scores 124 (or other selected model utilization metric as discussed previously) based on the concatenation of the searchable and non-searchable hyperparameter embeddings encoded from the two encoders (refer to prediction module 126 of FIG. 1), and (5) a collection of the respective caches of each search trial that can be stored into a database for future tuning and that can be transferred onto unseen tasks during the informed tuning (online phase) 304.

Bootstrapping (offline phase) 302 involves a series of steps for generating learned models 310 (the evolutionary sampler 114, the dynamic configuration encoder 130, the fixed configuration encoder 128, the MFU predictor 136) that can later be used in an online phase to generate MFU scores 124 and to general optimal configurations for a training task. One of the initial steps is to prepare one or more anchor tasks 306 having a range of parameters to ensure breadth in the respective search space. In some embodiments, each anchor task 306 includes a representative model type, training objective, and device option. A diversity of model types and task types helps to mitigate the cold-start tuning issue for future tasks provided by users 308 (refer to online phase). For example, selected anchor tasks 306 can be selected based on the following properties: model selection, such as model size (e.g., 1B to 180B parameters), model type (e.g., dense, mixture of experts (MoE), state space model (SSM), etc.), and model complexity (e.g., CUDA graph complexity), training objective selection, such as pretraining, instruction fine-tuning, LLM Alignment, etc., data type, such as prompt length, dataset size, etc., and device type selection, such as node type, number of nodes, number of GPUs, etc.

For example, a basket of anchor tasks 306 can include a first anchor task defined as tuning a Llama3-8B model pre-training on colossal clean crawled corpus (C4) data, a second anchor task defined as tuning a Llama3-70B model supervised fine-tuning on the ultra-chat 200k dataset, a third anchor task defined as tuning a Llama3-70B model RLHF alignment task on predetermined data (e.g., so-called ultrafeedback cleaned data, etc.), a fourth anchor task defined as tuning a mistral-7B model on long context data (e.g., LongAlphca-12k, etc.), a fifth anchor task defined as tuning a falcon 180B dense model on supervised fine-tuning on the ultra-chat 200k dataset, a sixth anchor task defined as tuning a mixtral-8*7B MoE model on supervised fine-tuning on ultra-chat 200k data, and a seventh anchor task defined as tuning an E5 mistral model for embedding generation task on a BEIR/MSMARO embedding-based retrieval dataset. The respective fixed configurations 102 and dynamic configurations 104 are stored for each of the anchor tasks 306 (refer to configuration profiling 142).

Once the anchor tasks 306 are prepared, the search space can be defined according to a selection of general training configurations (batch size, precision, checkpointing, etc.), distributed training configurations (FSDP, prefetching, etc.), and lower-level kernel configurations (kernel type, kernel hyperparameters, etc.).

Each anchor task can then be tuned in a sequential or distributed fashion as desired. This process involves a warmup phase in which a pool of candidate configurations is randomly sampled (e.g., 50 to 100 samples 118) for a current task search space and profile to get the respective MFU scores 124. In some embodiments, the dynamic configuration encoder 130 and the MFU predictor 136 can be trained jointly with the (sample 118, MFU score 124) pairs collected in the warmup stage. If the encoders are already trained (e.g., pre-trained), training can warm-start from the encoders. In some embodiments, to prevent so-called model forgetting, new task configurations are combined with the configurations for the previous tasks when further updating the encoders and/or MFU predictor 136. In some embodiments, MFU predictor 136 is a Bradley-Terry model trained with ranking loss (e.g., InfoNCE contrastive loss, lambda loss, etc.) to decide a ranking of candidate configurations given the model utilization metric targets (e.g., MFU targets) within each anchor task.

In some embodiments, tuning the anchor tasks 306 includes an iterative search process initiated by the evolutionary sampler 114, using an aging evolutionary search, to draw new candidate configurations (e.g., samples 118) based on mutating existing configurations. In some embodiments, existing configurations are mutated with aging constraints. More specifically, in some embodiments, evolutionary sampler 114 is configured for age-based population selection, in which, at each search run (e.g., an initiation of a single task search flow 100), the latest N (e.g., 50, 120, etc.) configurations are retrained based on their “age” (defined herein as the search time step at which the respective configuration was sampled and evaluated). This allows the evolutionary sampler 114 to preferentially rely upon relatively newer configurations. Once the latest N configurations are retrained, an MFU-based parent selection process can be initiated, whereby a top K percent (e.g., top 10 percent, top 15 percent, etc.) of candidates are selected from the population based on MFU score 124. One or more of the top K percent candidates can then be randomly sampled for exploration purposes as the parent of the new candidate. In some embodiments, the parent configuration is mutated by one or more operations (referred to as candidate configuration generation) and the resulting, new configuration is used as a new candidate. Optionally, in some embodiments, evolutionary sampler 114 selects two parent configurations and randomly selects parameters from each to compose a new candidate. The randomly selected parameters themselves can be mutated when generated the new candidate. Invalid configuration parameters can be adjusted as previously described.

In some embodiments, evolutionary sampler 114 can generate multiple candidate configurations and can leverage the learned MFU predictor 136 to filter out the “best” candidate for evaluation having the highest MFU score 124. In some embodiments, the MFU predictor 136 is not used in this manner until the model confidence in the predicted MFU scores 124 passes a predetermined threshold (e.g., ranking correlation scores such as Kendall Tau, Spearman's rho, etc., with an example threshold such as values greater than 0.5) with the ground truth 140. The end criteria for tuning the anchor tasks 306 can be set as desired, for example, to conclude after a predefined number of iterations for each anchor task and/or based on a predefined time constraint.

After tuning the anchor tasks 306, configuration profiling 142 initiates a low-fidelity profile process. Observe that configuration profiling can be time-consuming, especially for large networks. Thus, the low-fidelity profile process described herein adopts two simple strategies to reduce profiling costs while maintaining decent proxy accuracy: early stopping and configuration model utilization extrapolation.

Configuration profiling 142 can conduct early stopping based on runtime GPU metrics. For example, if GPU utilization and occupancy are below a predefined threshold, configuration profiling 142 can stop profiling the respective candidate and move to the next one. This represents a significant compute savings, as unpromising candidates can be discarded without a full analysis.

With configuration model utilization extrapolation, the correlation between MFU score 124 (or any other selected model utilization metric) and some specific hyperparameters in a given confirmation (e.g., sample 118) can be extrapolated based, for example, a scaling law. For example, given a group of profiling results of a specific training task on one, two, and four H100 GPUs respectively, we can extrapolate the MFU score 124 for the same groups of configurations on the same training task when only adjusting the GPU number to eight, thus avoiding running the full tuning process for all configurations. In some embodiments, the evolutionary sampler 114 and/or configuration profiling 142 can optionally select one or more configurations to run on the eight GPU setup to validate the extrapolation.

Informed tuning (online phase) 304 involves a series of steps for tuning a user-given training task in a live setting based on user requirements and resource constraints. Informed tuning begins with a warm-start process with search space matching and transfer. First, the fixed configurations 102 are encoded as a task embedding 132 to compare the similarity (e.g., using dot product) with anchor task embeddings in a database (refer to FIG. 2). Then, based on a predetermined similarity threshold, anchor tasks that have a highest similarity with respect to the target task(s) are selected. Lastly, the best hyperparameter(s) of each filtered anchor task are combined (e.g., weighted sums, where weights are the SoftMax of the similarities) and calibrations are applied to adjust each configuration hyperparameter in the derived configuration to its closest valid value in the search space 116. The resulting new configuration can serve as the starting configuration for direct adoption or continual tuning, as desired. If all anchor task similarities are below the predefined threshold, the closest anchor task can be used as the starting configuration to reduce the search space 116.

The next step in informed tuning 304 is the initiation of a search process. The search process can be conducted differently depending on the amount of time and compute resources available to the user for a given training task. In particular, if a user has only a limited time to wait or does not have enough compute resources for full searching, a GPU free search can be initiated. During GPU free search, the single task search flow 100 and/or efficiency tuning system 300 can start from the target task warm-start 208 (refer to FIG. 2) and can randomly sample a fixed amount of configurations to estimate their MFU scores 124 using the dynamic configuration encoder 130, fixed configuration encoder 128, and MFU predictor 136 predictor model (refer to FIG. 1), thereby allowing the determination of an optimal configuration without full GPU testing. Alternatively, with available time and compute resources, a continuous online search can be initiated that follows the same process as offline tuning (refer to bootstrapping 302) but retains an initial population pool as one warmup configuration without extra random sampling and profiling (e.g., of 50, 100, etc., configurations as discussed with respect to bootstrapping 302).

Alternatively, or in addition, informed tuning 304 can include, as part of or separate from the search process described previously, a mixed search strategy that balances exploration 312 and exploitation. Observe that a given similarity calculation can be biased towards one single task and that respective anchor tasks may not fully characterize the entire task space. To address these related issues, a mixed search strategy can be used that combines the originally aging evolutionary search with random sampling (referred to herein as exploration 312) during the online tuning process—in other words, iteratively conduct one-step random sampling within the acceptable scope of the search space 116 for each one step of an evolutionary search. This mixed search strategy can be configured to stop based on a user-predefined number of search trials and/or a wall-clock tuning time.

In any case, informed tuning 304 can include cache collection and database update, whereby a database is augmented with the newly acquired tuning tasks and profiling results. The cached data can later be used to inform and accelerate the tuning process for new tasks by providing a rich repository of previously evaluated configurations and their performance metrics. By leveraging this historical data, the efficiency tuning system 300 can make more informed decisions and can reduce the need for exhaustive searches, thereby improving training efficiency and reducing computational requirements.

FIG. 4 depicts a block diagram of a search process flow 400 for optimizing large language model training configurations in accordance with one or more embodiments. As shown in FIG. 4, search process flow 400 includes inputting the fixed configurations 102 and checking (via cache check 402) if a cached optimal searchable configuration 404 exists for the respective input combination of fixed configurations 102. If a cached optimal searchable configuration 404 exists (“Yes”), the search process flow 400 can directly return the cached optimal configuration 404, bypassing the remaining steps at significant savings in terms of both time and computer. If a cached optimal searchable configuration 404 is not available (“No”), search process flow 400 proceeds to search space generator 406 to build a search space 116 that enumerates potential configurations to maximize training efficiency (refer to FIGS. 1 and 2 for a discussion of the search space 116).

Once a search space 116 is defined, the search process flow 400 can continue to a check for distributed tuning 408. A parallel search 410 or serial search 412 can be initiated depending on whether distributed tuning is available. In either case, a number of single task search flows 100 are searched with model feedback 414 (refer to feedback loop 144 of FIG. 1), with the primary difference being that, during parallel search 410, all single task search flows 100 are searched in parallel, while, with serial search 412, each single task search flow 100 is searched separately. In other words, the search process flow 400 can be distributed if the respective task contains enough resources; otherwise, it uses sequential tuning.

FIG. 5 depicts a block diagram for generating model execution graphs 106 in accordance with one or more embodiments. Specifically, FIG. 5 describes the generation of a CUDA kernel model execution graph 500. A model execution graph is a representation of a sequence of operations (e.g., “op1”, “op2”, . . . , “opN”, . . . , “loss”), that a model performs during its execution on a GPU.

As shown in FIG. 5, a first CUDA model 502 and a second CUDA model 504 contain, respectively, input layers 506 and output layers 508 separated by a number of fully connected layers 510 (as shown, two, although other internal layer configurations are possible). Each of the input layers 506, output layers 508, and fully connected layers 510 contain one or more nodes 512 connected via edges 514.

As further shown in FIG. 5, the CUDA kernel model execution graph 500 specifically refers to a directed acyclic graph (DAG) having a plurality of execution graph nodes 516 connected via a plurality of execution graph edges 518. Each execution graph node 516 represents a computational operation (or kernel) of a respective CUDA model, and each execution graph edge 518 represents the data dependencies between the respective operations. A CUDA kernel model execution graph 500 fully defines the mathematical operations of the respective model (e.g., the first CUDA model 502 and/or second CUDA model 504) and ensures that the operations are correctly executed on the GPU.

More specifically, each execution graph node 516 in the CUDA kernel model execution graph 500 represents a CUDA kernel, which is a function that runs on a GPU. These kernels perform specific computations, such as matrix multiplications, convolutions, or activation functions. The execution graph edge 518 represent the data dependencies between these kernels. For example, an edge from a first node (e.g., “op1”) to a second node (e.g., “op2”) indicates that the output of kernel “op1” is used as input for “op2”. Parallelism: The graph structure allows for the identification of independent operations that can be executed in parallel, thereby maximizing the utilization of the GPU's computational resources.

In the context of the single task search flow 100 and efficiency tuning system 300, the CUDA kernel model execution graph 500 defines part of the fixed configurations 102 and serves as a baseline for ensuring that a respective model's computations are correctly executed on the corresponding GPUs. In other words, the CUDA kernel model execution graph 500 provides a portion of the fixed parameter structure within which the dynamic configurations 104 can be optimized to improve training efficiency.

Turning now to FIG. 6, in some embodiments, one or more of the single task search flow 100 (refer to FIG. 1), search transfer 200 (refer to FIG. 2), efficiency tuning system 300 (refer to FIG. 3), search process flow 400 (refer to FIG. 4), and/or model execution graph generation (refer to FIG. 5), can be implemented in whole or in part using a transformer architecture (e.g., transformer 600), such as those relied upon in some large language models (LLMs). For example, in some embodiments, dynamic configuration encoder 130 and/or fixed configuration encoder 128 are transformer-type encoders. In some embodiments, MFU predictor 136 is implemented as a transformer-type encoder, decoder, and/or combination thereof.

While not meant to be particularly limited, large language models are neural network machine learning architectures that are capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

As shown in FIG. 6, the transformer-based architecture for transformer 600 begins with an input 602. The input 602 denotes an input provided by a user (or upstream system) and can be represented as a sequence of tokens, individual words or sub-words, from which input embeddings 604 can be generated. The input embeddings 604 represent the tokens within the input 602 as numbers, which can be processed using encoder 606. In some embodiments, a positional encoding 608 can be generated to encode the position of each token in input 602 as a set of numbers. These numbers can be fed into the encoder 606 with the input embeddings 604, allowing the transformer-based architecture to more effectively understand the order of words in a sentence and to thereby generate grammatically correct and semantically meaningful outputs.

The encoder 606 processes the input embeddings 604 and the positional encoding 608 and generates, for the input 602, an encoded representation 610 (in this implementation, the candidate configuration embedding 134, task embedding 132, MFU score 124 of the dynamic configuration encoder 130, fixed configuration encoder 128, and MFU predictor 136, respectively) that captures the meaning and context of the input 602. To accomplish this, encoder 606 applies a series of self-attention transformer layers (or simply, “transformer layers”), which are a series of hidden states that represent the input 602 at different levels of abstraction. The encoder 606 can include any number of these transformer layers, as desired. In some embodiments, the encoded representation 610 is provided to a decoder 612.

The decoder 612 similarly includes a number of transformer layers, as desired, except that the decoder 612 processes an output 614. In most implementations, the output 614 is a right-shifted copy of the input 602, meaning that the decoder 612 can only use the previous words for next-word prediction. In some embodiments, output embeddings 616 can be generated from the output 614 to represent the tokens in the output 614 as numbers, in a similar manner as described with respect to the encoder 606. A positional encoding 618 can be added to the output embeddings 616 to encode the position of each token in output 614 as a set of numbers. The decoder 612 can be trained by minimizing a loss function (also known as an objective function, which quantifies a difference between a predicted output and a known true value) using, for example, gradient descent. Once trained, the transformer-based meta block 106 can be used during an inference phase to generate an output 620, which can be thought of as a next-word probability (that is, how likely is the next word in the sequence to be x, or y, etc.). In some configurations, the transformer-based architecture includes a linear layer and SoftMax layer (omitted for clarity) to transform a raw output from the decoder 612 into the output 614. For example, after the decoder 612 produces a raw output (e.g., output embeddings), the linear layer can map the output embeddings to a higher-dimensional space, thereby transforming the output embeddings into a same original input space as the input 602. The SoftMax function can be used to generate a probability distribution for each output token in the vocabulary, enabling the transformer-based meta block 106 to generate output tokens with probabilities (e.g., the output 620).

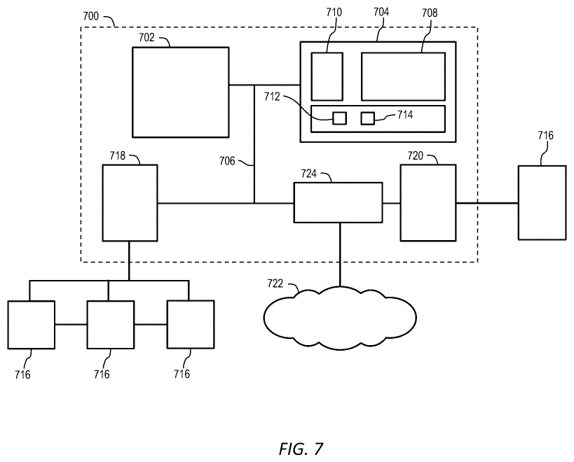

FIG. 7 illustrates aspects of an embodiment of a computer system 700 that can perform various aspects of embodiments described herein. In some embodiments, the computer system(s) 700 can implement and/or otherwise be incorporated within or in combination with the single task search flow 100 (refer to FIG. 1), search transfer 200 (refer to FIG. 2), efficiency tuning system 300 (refer to FIG. 3), search process flow 400 (refer to FIG. 4), model execution graph generation (refer to FIG. 5), and/or transformer 600 (refer to FIG. 6). In some embodiments, a computer system 700 can be implemented server-side. For example, a remote computer system 700 can be configured to receive a request corresponding to a machine learning model training task, and in response, to generate and return an optimal training efficiency configuration for the task.

The computer system 700 includes at least one processing device 702, which generally includes one or more processors or processing units for performing a variety of functions, such as, for example, completing any portion of the content moderation service 100 described previously. Components of the computer system 700 also include a system memory 704, and a bus 706 that couples various system components including the system memory 704 to the processing device 702. The system memory 704 may include a variety of computer system readable media. Such media can be any available media that is accessible by the processing device 702, and includes both volatile and non-volatile media, and removable and non-removable media. For example, the system memory 704 includes a non-volatile memory 708 such as a hard drive, and may also include a volatile memory 710, such as random access memory (RAM) and/or cache memory. The computer system 700 can further include other removable/non-removable, volatile/non-volatile computer system storage media.

The system memory 704 can include at least one program product having a set (e.g., at least one) of program modules that are configured to carry out functions of the embodiments described herein. For example, the system memory 704 stores various program modules that generally carry out the functions and/or methodologies of embodiments described herein. A module or modules 712, 714 may be included to perform functions related to any of the block diagrams described herein. The computer system 700 is not so limited, as other modules may be included depending on the desired functionality of the computer system 700. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 702 can also be configured to communicate with one or more external devices 716 such as, for example, a keyboard, a pointing device, and/or any devices (e.g., a network card, a modem, etc.) that enable the processing device 702 to communicate with one or more other computing devices. Communication with various devices can occur via Input/Output (I/O) interfaces 718 and 720.

The processing device 702 may also communicate with one or more networks 722 such as a local area network (LAN), a general wide area network (WAN), a bus network and/or a public network (e.g., the Internet) via a network adapter 724. In some embodiments, the network adapter 724 is or includes an optical network adaptor for communication over an optical network. It should be understood that although not shown, other hardware and/or software components may be used in conjunction with the computer system 700. Examples include, but are not limited to, microcode, device drivers, redundant processing units, external disk drive arrays, RAID systems, and data archival storage systems, etc.

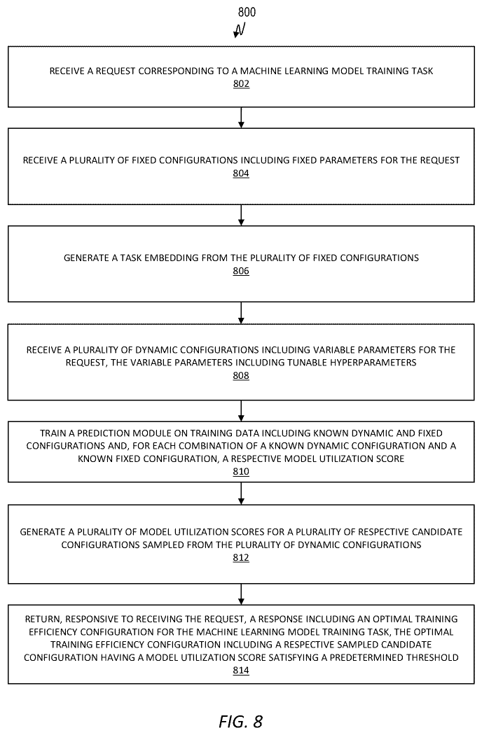

Referring now to FIG. 8, a flowchart 800 for efficiency tuning is generally shown according to an embodiment. The flowchart 800 is described with reference to FIGS. 1 to 7 and may include additional steps not depicted in FIG. 8.

Although depicted in a particular order, the blocks depicted in FIG. 8 can be, in some embodiments, rearranged, subdivided, and/or combined.

At block 802, the method includes receiving a request corresponding to a machine learning model training task.

At block 804, the method includes receiving a plurality of fixed configurations including fixed parameters for the request.

At block 806, the method includes generating a task embedding from the plurality of fixed configurations.

At block 808, the method includes receiving a plurality of dynamic configurations that include variable parameters for the request. In some embodiments, the variable parameters include tunable hyperparameters.

At block 810, the method includes training a prediction module (e.g., prediction module 126) on training data that includes known dynamic and fixed configurations and, for each combination of a known dynamic configuration and a known fixed configuration, a respective model utilization score. In some embodiments, the model utilization score is a model floating-point operations per second (FLOPS) utilization (MFU) score.

At block 812, the method includes generating, from the prediction module, a plurality of model utilization scores (e.g., MFU scores) for a plurality of respective candidate configurations sampled from the plurality of dynamic configurations. In some embodiments, generating each model utilization score includes sampling a candidate configuration from the plurality of searchable configurations. In some embodiments, the candidate configuration includes candidate parameter values (e.g., hyperparameters and other parameters that improve the efficiency of the training process but do not affect the learning pattern of the machine learning model). In some embodiments, generating each model utilization score includes generating a candidate configuration embedding from the respective sampled candidate configuration. In some embodiments, generating each model utilization score includes generating, responsive to inputting the candidate configuration embedding and the task embedding to the prediction module, a model utilization score for the respective sampled candidate configuration. In some embodiments, the candidate configuration embedding and the task embedding are concatenated prior to inputting the resulting concatenation to the prediction module.

At block 814, the method includes returning, responsive to receiving the request, a response including an optimal training efficiency configuration for the machine learning model training task. As used herein, an “optimal training efficiency configuration” means a configuration that maximizes training efficiency—that is, to maximize a selected model utilization metric, such as model floating-point operations per second (FLOPS) utilization (MFU) scores. In some embodiments, the optimal training efficiency configuration (or simply, training configuration) includes a respective sampled candidate configuration having a model utilization score that satisfies a predetermined threshold. For example, in some embodiments, the optimal training efficiency configuration includes the respective sampled candidate configuration having a highest MFU score. For other model utilization scores, the optimal training efficiency configuration can be a lowest score, a highest score, or a score within a predetermined threshold, as appropriate for each respective model utilization score.

In some embodiments, generating the task embedding includes training a first encoder to generate embeddings from fixed configurations. In some embodiments, the first encoder is trained on a training set that includes known fixed configurations and their respective task embeddings. In some embodiments, generating the task embedding includes inputting the plurality of fixed configurations to the first encoder and outputting, from the first encoder, the task embedding.

In some embodiments, generating a respective candidate configuration embedding includes training a second encoder to generate embeddings from dynamic configurations, inputting the respective sampled candidate configuration to the second encoder, and outputting, from the second encoder, the respective candidate configuration embedding.

In some embodiments, the fixed configurations include at least one of a model execution graph, model configuration parameters, device configuration parameters, or data configuration parameters. In some embodiments, the fixed configurations include the model execution graph, the model configuration parameters, the device configuration parameters, and the data configuration parameters.

In some embodiments, sampling from the plurality of dynamic configurations includes selecting one or more samples from a search space according to a similarity-based transfer corresponding to the machine learning model training task.

In some embodiments, sampling from the plurality of dynamic configurations further includes comparing the task embedding with task embeddings of one or more anchor tasks in the search space to determine similarity scores, selecting one or more anchor tasks based on the similarity scores, and combining two or more configurations of the selected anchor tasks according to a weighted sum of respective configuration values of the two or more configurations. In some embodiments, weights are applied to respective configuration values according to the similarity scores.

In some embodiments, sampling from the plurality of dynamic configurations further includes calibrating the combined two or more configurations by adjusting each configuration value to a closest valid value in a target task search space, thereby resulting in a warm-start configuration for the machine learning model training task.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or”unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer to produce a machine, such that the instructions, which execute via the processor of the special purpose computer, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method comprising:
receiving a request corresponding to a machine learning model training task;
receiving a plurality of fixed configurations comprising fixed parameters for the request;
generating a task embedding from the plurality of fixed configurations;
receiving a plurality of dynamic configurations comprising variable parameters for the request, the variable parameters comprising tunable hyperparameters;
training a prediction module on training data comprising known dynamic and fixed configurations and, for each combination of a known dynamic configuration and a known fixed configuration, a respective model utilization score;
generating, from the prediction module, a plurality of model utilization scores for a plurality of respective candidate configurations sampled from the plurality of dynamic configurations, wherein generating the model utilization score comprises:
sampling a candidate configuration from the plurality of dynamic configurations, the candidate configuration comprising candidate parameter values;
generating a candidate configuration embedding from the respective sampled candidate configuration; and
generating, responsive to inputting the candidate configuration embedding and the task embedding to the prediction module, a model utilization score for the respective sampled candidate configuration; and
returning, responsive to receiving the request, a response comprising a training configuration for the machine learning model training task, the training configuration comprising a respective sampled candidate configuration having a model utilization score satisfying a predetermined threshold.

2. The method of claim 1, wherein generating the task embedding comprises:
training a first encoder to generate embeddings from fixed configurations, the first encoder trained on a training set comprising known fixed configurations and their respective task embeddings;
inputting the plurality of fixed configurations to the first encoder; and
outputting, from the first encoder, the task embedding.

3. The method of claim 2, wherein generating a respective candidate configuration embedding comprises:
training a second encoder to generate embeddings from dynamic configurations;
inputting the respective sampled candidate configuration to the second encoder; and
outputting, from the second encoder, the respective candidate configuration embedding.

4. The method of claim 1, wherein the fixed configurations comprise one or more of a model execution graph, model configuration parameters, device configuration parameters, or data configuration parameters.

5. The method of claim 1, wherein sampling from the plurality of dynamic configurations comprises selecting one or more samples from a search space according to a similarity-based transfer corresponding to the machine learning model training task.

6. The method of claim 5, wherein sampling from the plurality of dynamic configurations further comprises:
comparing the task embedding with task embeddings of one or more anchor tasks in the search space to determine similarity scores;
selecting one or more anchor tasks based on the similarity scores; and
combining two or more configurations of the selected anchor tasks according to a weighted sum of respective configuration values of the two or more configurations, wherein weights are applied to respective configuration values according to the similarity scores.

7. The method of claim 6, wherein sampling from the plurality of dynamic configurations further comprises calibrating the combined two or more configurations by adjusting each configuration value to a closest valid value in a target task search space, thereby resulting in a warm-start configuration for the training task.

8. A system comprising a memory, computer readable instructions, and one or more circuitry for executing the computer readable instructions, the computer readable instructions controlling the one or more circuitry to perform operations comprising:
receive a request corresponding to a machine learning model training task;
receive a plurality of fixed configurations comprising fixed parameters for the request;
generate a task embedding from the plurality of fixed configurations;
receive a plurality of dynamic configurations comprising variable parameters for the request, the variable parameters comprising tunable hyperparameters;
train a prediction module on training data comprising known dynamic and fixed configurations and, for each combination of a known dynamic configuration and a known fixed configuration, a respective model utilization score;
generate, from the prediction module, a plurality of model utilization scores for a plurality of respective candidate configurations sampled from the plurality of dynamic configurations, wherein generating the model utilization score comprises:
sample a candidate configuration from the plurality of dynamic configurations, the candidate configuration comprising candidate parameter values;
generate a candidate configuration embedding from the respective sampled candidate configuration; and
generate, responsive to inputting the candidate configuration embedding and the task embedding to the prediction module, a model utilization score for the respective sampled candidate configuration; and
returning, responsive to receiving the request, a response comprising a training configuration for the machine learning model training task, the training configuration comprising a respective sampled candidate configuration having a model utilization score satisfying a predetermined threshold.

9. The system of claim 8, wherein generating the task embedding comprises controlling the one or more circuitry to perform operations comprising:
train a first encoder to generate embeddings from fixed configurations, the first encoder trained on a training set comprising known fixed configurations and their respective task embeddings;
input the plurality of fixed configurations to the first encoder; and
output, from the first encoder, the task embedding.

10. The system of claim 9, wherein generating a respective candidate configuration embedding comprises controlling the one or more circuitry to perform operations comprising:
train a second encoder to generate embeddings from dynamic configurations;
input the respective sampled candidate configuration to the second encoder; and
output, from the second encoder, the respective candidate configuration embedding.

11. The system of claim 8, wherein the fixed configurations comprise one or more of a model execution graph, model configuration parameters, device configuration parameters, or data configuration parameters.

12. The system of claim 8, wherein sampling from the plurality of dynamic configurations comprises controlling the one or more circuitry to perform operations comprising:
select one or more samples from a search space according to a similarity-based transfer corresponding to the machine learning model training task.

13. The system of claim 12, wherein sampling from the plurality of dynamic configurations further comprises controlling the one or more circuitry to perform operations comprising:
compare the task embedding with task embeddings of one or more anchor tasks in the search space to determine similarity scores;
select one or more anchor tasks based on the similarity scores; and
combine two or more configurations of the selected anchor tasks according to a weighted sum of respective configuration values of the two or more configurations, wherein weights are applied to respective configuration values according to the similarity scores.

14. The system of claim 13, wherein sampling from the plurality of dynamic configurations further comprises controlling the one or more circuitry to perform operations comprising:
calibrate the combined two or more configurations by adjusting each configuration value to a closest valid value in a target task search space, thereby resulting in a warm-start configuration for the machine learning model training task.

15. A computer program product comprising a computer readable storage medium having program instructions embodied therewith, the program instructions executable by one or more circuitry to cause the one or more circuitry to perform operations comprising:
receive a request corresponding to a machine learning model training task;
receive a plurality of fixed configurations comprising fixed parameters for the request;
generate a task embedding from the plurality of fixed configurations;
receive a plurality of dynamic configurations comprising variable parameters for the request, the variable parameters comprising tunable hyperparameters;
train a prediction module on training data comprising known dynamic and fixed configurations and, for each combination of a known dynamic configuration and a known fixed configuration, a respective model utilization score;
generate, from the prediction module, a plurality of model utilization scores for a plurality of respective candidate configurations sampled from the plurality of dynamic configurations, wherein generating the model utilization score comprises:
sample a candidate configuration from the plurality of dynamic configurations, the candidate configuration comprising candidate parameter values;
generate a candidate configuration embedding from the respective sampled candidate configuration; and
generate, responsive to inputting the candidate configuration embedding and the task embedding to the prediction module, a model utilization score for the respective sampled candidate configuration; and
return, responsive to receiving the request, a response comprising a training configuration for the machine learning model training task, the training configuration comprising a respective sampled candidate configuration having a model utilization score satisfying a predetermined threshold.

16. The computer program product of claim 15, wherein generating the task embedding comprises causing the one or more circuitry to perform operations comprising:
train a first encoder to generate embeddings from fixed configurations, the first encoder trained on a training set comprising known fixed configurations and their respective task embeddings;
input the plurality of fixed configurations to the first encoder; and
output, from the first encoder, the task embedding.

17. The computer program product of claim 16, wherein generating a respective candidate configuration embedding comprises causing the one or more circuitry to perform operations comprising:
train a second encoder to generate embeddings from dynamic configurations;
input the respective sampled candidate configuration to the second encoder; and
output, from the second encoder, the respective candidate configuration embedding.

18. The computer program product of claim 15, wherein the fixed configurations comprise one or more of a model execution graph, model configuration parameters, device configuration parameters, or data configuration parameters.

19. The computer program product of claim 15, wherein sampling from the plurality of dynamic configurations comprises causing the one or more circuitry to perform operations comprising:
select one or more samples from a search space according to a similarity-based transfer corresponding to the machine learning model training task.

20. The computer program product of claim 19, wherein sampling from the plurality of dynamic configurations further comprises causing the one or more circuitry to perform operations comprising:
compare the task embedding with task embeddings of one or more anchor tasks in the search space to determine similarity scores;
select one or more anchor tasks based on the similarity scores; and
combine two or more configurations of the selected anchor tasks according to a weighted sum of respective configuration values of the two or more configurations, wherein weights are applied to respective configuration values according to the similarity scores.
